(19) United States
(12) Patent Application Publication
(10) Pub. No.: US 2015/0046564 A1
(43) Pub. Date: Feb. 12, 2015

(54) METHOD AND APPARATUS FOR TRANSMITTING CONTENT RELATED DATA TO AT LEAST ONE GROUPED CLIENT IN CLOUD ENVIRONMENT

(71) Applicant: Samsung Electronics Co., Ltd., Gyeonggi-do (KR)

(72) Inventors: Jae-hong Kim, Gyeonggi-do (KR); Joong-hwan Lee, Gyeonggi-do (KR); Sung-won Han, Seoul (KR); Eun-ho Heo, Seoul (KR)

(73) Assignee: Samsung Electronics Co., Ltd.

(21) Appl. No.: 14/445,666

(22) Filed: Jul. 29, 2014

(30) Foreign Application Priority Data
Aug. 8, 2013 (KR) 10-2013-0094321

(51) Int. Cl. H04L 29/08

(52) U.S. Cl. CPC H04L 67/10
USPC 709/217

(57) ABSTRACT

A method of transmitting content data to at least one client that is grouped in a cloud environment is provided. The method includes receiving content use influence information for each client; determining a reference client based on the content use influence information; controlling to generate a group including at least one neighbor client that has similar information as content preference information of the reference client; and transmitting content data used by the reference client to the at least one neighbor client included in the generated group.

### PRIORITY

This application claims priority under 35 U.S.C. §119(a) to Korean Patent Application No. 10-2013-0094321, filed in the Korean Intellectual Property Office on Aug. 8, 2013, the entire disclosure of which is incorporated herein by reference.

### BACKGROUND

1. Field of the Invention

The present invention generally relates to a method and apparatus for transmitting content data to at least one client that is grouped in a cloud environment, and more particularly, to a method and apparatus for grouping at least one neighbor client based on a content use pattern of a reference client who has a high influence on neighbor clients in terms of content use, and for transmitting content-related data to the grouped neighbor client.

2. Description of the Related Art

A Content Delivery Network (CDN) refers to a content transmission technique suggested to address an increase in Internet use which is a cause of congestion of network traffic and to overcome the limits in caching strategy.

A CDN distributes a plurality of servers to edges of a network to improve Internet service quality, stores replicated content, and allows a replicate server (e.g., an edge node) which is near a client to respond to a content request made by the client to thereby quickly provide the client with a service.

In addition, a CDN is an advancement of a caching technique; caching is usually designed to be conducted based on a local network to store content that are frequently requested by clients, whereas in a CDN, replicate servers distributed overall in a network are managed and content that are selected according to a policy are stored.

In other words, a CDN refers to a content transmission technique whereby content, which are concentrated in a web server of a content provider who is distant from clients (e.g., large-capacity content, such as a video or an audio, or content that are frequently used by clients), are stored in advance in host servers that are widely distributed at Points of Presences (PoPs) of multiple Internet Service Providers (ISPs), and content are provided via a host server that is the nearest to a corresponding client upon a request by the client. The host server may also be referred to as a cache server, replicate server, edge server, or ghost server.

In detail, the content provider concludes a service contract with a CDN service supplier, and transfers content to be provided, to the CDN service supplier. Then, the CDN service provider stores the received content in an edge node (a host server or the like) that is distributed in a network overall. When the CDN service supplier receives a request to provide predetermined content, the CDN service supplier provides the client with corresponding content via an edge node at the nearest position to the client.

By transmitting content via the CDN, a data processing speed between a client and a server may be improved, and an overload of traffic of a content provider server may be prevented. In addition, a balance in traffic load between the content provider server and a host server may be maintained.

According to the conventional art, not every piece of content requested by a client has been able to be cached. Thus, caching is performed mainly on content having relatively high preference by at least one client to thereby increase caching efficiency.

Also, while only the concept of content prefetching to a host server or the like has been available, research on methods for efficient prefetching (e.g., selecting content for prefetching, selecting an object for prefetching, etc.) have been not sufficiently conducted.

In addition, only a prefetching method based on a content use pattern of a single user has been used according to the conventional art. In other words, under the conventional art, it is unknown whether a plurality of users (e.g., clients) that show similar content use patterns can be grouped in a group and content are prefetched based on this group.

Also, when caching content according to the conventional art, the particularity of a social network service or the like has not been considered (e.g., vagueness of boundaries between a publisher and a subscriber). For example, when a user does a predetermined action with respect to predetermined content (e.g., posting a comment), this produces the effect of advertising the corresponding content to nearby users, causing an effect of serial consumption of content between users.

However, as described above, particularity of a social network service in content caching has not been considered according to the conventional art, and thus, a relationship between use of content by a predetermined user and use (consumption) of content by nearby users has been often neglected in content caching (or prefetching).

### SUMMARY

The present invention has been made to address the above problems and disadvantages, and to provide at least the advantages described below. Accordingly, an aspect of the present invention provides a method and apparatus for transmitting content data to at least one client that is grouped in a cloud environment.

Another aspect of the present invention provides a method of generating content use influence information with respect to at least one neighbor client in a cloud environment and transmitting the information to a server, and a client that performs the method.

According to an aspect of the present invention, a method of transmitting content data to at least one client that is grouped in a cloud environment, includes receiving content use influence information for each client; determining a reference client based on the content use influence information; controlling to generate a group including at least one neighbor client that has similar information as content preference information of the reference client; and transmitting content data used by the reference client to the at least one neighbor client included in the generated group.

According to another aspect of the present invention, a method of transmitting data includes obtaining profile information of a client; generating content use influence information about at least one neighbor client based on the obtained profile information; and transmitting the content use influence information to a server.

According to another aspect of the present invention, an apparatus for transmitting content data to at least one client that is grouped in a cloud environment includes an information receiving unit for receiving content use influence information for each client; a reference client determiner for determining a reference client based on the content use influence information; a group generator for controlling to generate a group including at least one neighbor client that has similar information as content preference information of the reference client; and a transmitter for transmitting content data used by the reference client to the at least one neighbor client included in the generated group.

According to another aspect of the present invention, a method of transmitting, in a cloud environment including a first content delivery network (CDN) and a second CDN, content data to at least one client that is included in the second CDN and is grouped, includes receiving content use influence information for each client included in the first CDN; determining a reference client based on the content use influence information; controlling to generate a group including at least one neighbor client that has similar information as content preference information of the reference client; and transmitting content data used by the reference client included in the first CDN to the at least one neighbor client included in the generated group of the second CDN.

According to another aspect of the present invention, an apparatus for transmitting, in a cloud environment including a first content delivery network (CDN) and a second CDN, content data to at least one client that is included in the second CDN and is grouped, includes an information receiving unit for receiving content use influence information for each client, included in the first CDN; a reference client determiner for determining a reference client based on the content use influence information; a group generator for controlling to generate a group including at least one neighbor client that has similar information as content preference information of the reference client; and a transmitter for transmitting content data used by the reference client included in the first CDN to the at least one neighbor client included in the generated group of the second CDN.

According to another aspect of the present invention, a method of transmitting, in a cloud environment including a first content delivery network (CDN) and a second CDN, content data to at least one client that is included in the second CDN and is grouped, includes receiving content use influence information for each client included in the first CDN; determining a reference client based on the content use influence information; transmitting a first signal to the second CDN to generate a group including at least one neighbor client that has relevant information as content preference information of the reference client; and transmitting a second signal to a server to transmit content data used by the reference client included in the first CDN to the at least one neighbor client included in the generated group of the second CDN.

According to one or more embodiments of the present invention, a non-transitory computer readable recording medium having embodied thereon a program for executing the method described above is included.

### BRIEF DESCRIPTION OF THE DRAWINGS

The above and other aspects, features and advantages of the present invention will become apparent and more readily appreciated from the following description of the embodiments, taken in conjunction with the accompanying drawings, in which:

FIG. 1 is a schematic view illustrating a method of transmitting content data to at least one client that is grouped in a cloud environment, according to an embodiment of the present invention;

FIG. 2 is a flowchart illustrating a method of transmitting content data to at least one client that is grouped in a cloud environment, according to an embodiment of the present invention;

FIG. 3 is a flowchart illustrating a method of generating a group based on an impact factor (IF) of a reference client and content preference similarity, according to an embodiment of the present invention;

FIG. 4 is a flowchart illustrating a method of generating a group based on daily content usage amounts of a reference client and content preference similarity, according to an embodiment of the present invention;

FIG. 5 is a flowchart illustrating a method of generating content use influence information in a client and transmitting the content use influence information to a server, according to an embodiment of the present invention;

FIG. 6 illustrates a block diagram of an apparatus for transmitting content data to at least one client that is grouped in a cloud environment, according to an embodiment of the present invention;

FIG. 7 illustrates a block diagram of an apparatus for transmitting content data to at least one client that is grouped based on an IF in a cloud environment, according to an embodiment of the present invention;

FIG. 8 illustrates a block diagram of an apparatus for transmitting content data to at least one client that is grouped based on content use information in a cloud environment, according to an embodiment of the present invention;

FIG. 9 illustrates a block diagram of an apparatus for transmitting content data to at least one client that is grouped in a cloud environment, according to an embodiment of the present invention;

FIG. 10 illustrates a block diagram of a client that generates content use influence information and transmits the content use influence information to a server, according to an embodiment of the present invention;

FIG. 11 is a schematic view illustrating a method of transmitting content data between different networks, according to an embodiment of the present invention; and

FIG. 12 is a flowchart illustrating a method of transmitting content data between different networks, according to an embodiment of the present invention.

### DETAILED DESCRIPTION OF EMBODIMENTS OF THE PRESENT INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present invention. Expressions such as “at least one of,” when preceding a list of elements, modify the entire list of elements and do not modify the individual elements of the list.

Hereinafter, the terms used in the specification will be briefly described, and then the present invention will be described in detail.

The terms used in this specification are those general terms currently widely used in the art in consideration of functions in regard to the present invention, but the terms may vary according to the intention of those of ordinary skill in the art, precedents, or new technology in the art. Also, specific terms may be selected, and in this case, the detailed meaning thereof will be described in the detailed description of the invention. Thus, the terms used in the specification should be understood not as simple names but based on the meaning of the terms and the overall description of the invention.

Throughout the specification, it will also be understood that when a component “includes” an element, unless there is another opposite description thereto, it should be understood that the component does not exclude another element but may further include another element. In addition, terms such as “ . . . unit”, “ . . . module”, or the like refer to units that perform at least one function or operation, and the units may be implemented as hardware or software or as a combination of hardware and software.

The invention now will be described more fully hereinafter with reference to the accompanying drawings, in which illustrative embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those of ordinary skill in the art.

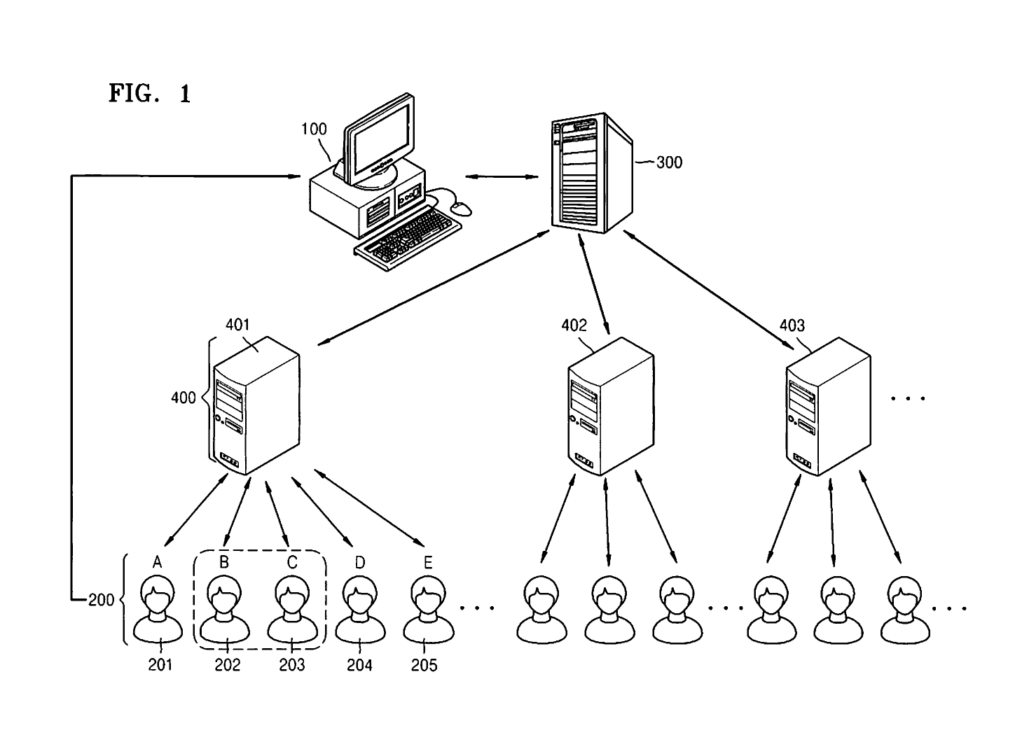

FIG. 1 is a schematic view illustrating a method of transmitting content data to at least one client that is grouped in a cloud environment, according to an embodiment of the present invention.

A content provider (CP) 100 transmits content data which is highly demanded by at least one user 200 to a source server 300 in advance. The source server 300 transmits content data in advance to a host server (or an edge server) 400 which is geographically separated therefrom or which may be separated therefrom according to a policy. By distributing content data in this manner, at least one user 200 may quickly obtain content data.

In addition, the content provider 100 may distribute the data traffic load which is caused when the at least one user 200 has to transmit or receive data that is temporarily concentrated or a large amount of content data at one time.

In order to effectively distribute content data according to the embodiment of the present invention, a reference user whose content use has a large impact on nearby users (e.g., a user A 201) is determined, and a group including at least one neighbor client (e.g., a user B 202 and a user C 203) having similar information as content preference information of the reference user (e.g., content use pattern information) is generated, and the content data used by the reference client may be transmitted to the at least one neighbor client included in the group.

The content data may include multimedia data such as a picture, a video or an audio, or record data such as a document.

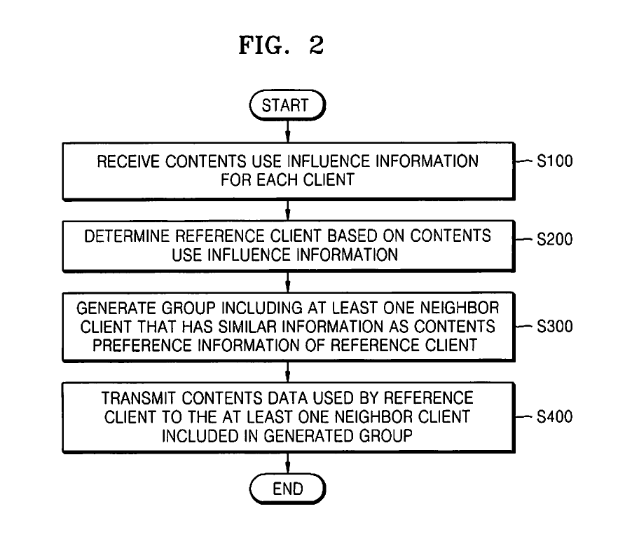

FIG. 2 is a flowchart illustrating a method of transmitting content data to at least one client that is grouped in a cloud environment, according to an embodiment of the present invention.

The method of transmitting content data to at least one client that is grouped in a cloud environment is provided. In step S100, content use influence information is received for each client. In step S200, a reference client is determined based on the content use influence information. In step S300, a group including at least one neighbor client that has similar information as content preference information of the reference client is generated. In step S400, content data used by the reference client is transmitted to the at least one neighbor client included in the generated group.

In addition, the content use influence information for each client may include at least one of an impact factor (IF) regarding a neighbor client for each client and a daily content usage amount for each client.

In addition, the content use influence information for each client may be obtained in predetermined period units. For example, the content use influence information may be obtained in predetermined time periods, that is, on a daily basis or a monthly basis.

In addition, the reference client according to the embodiment of the present invention may be a client whose content use influence information for each client satisfies predetermined standards.

For example, if the content use influence information is an IF regarding a neighbor client for each client, a client having the highest IF may be a reference client. In addition, if the content use influence information is a daily content usage amount according to clients, a user whose daily content usage amount is the highest may be a reference client for a corresponding day.

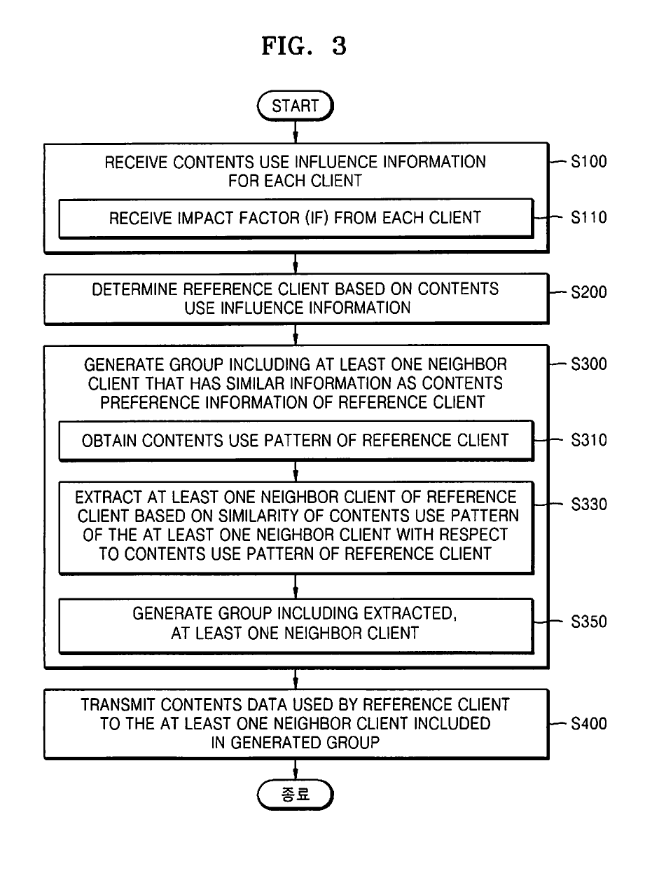

FIG. 3 is a flowchart illustrating a method of generating a group based on an impact factor (IF) of a reference client and content preference similarity, according to an embodiment of the present invention.

Step S100 of receiving of content use influence information for each client includes step S110 of receiving the IF from each client.

The IF is generated in each client based on profile information of a client. The profile information of the client includes at least one of a number of neighbor clients of the client, a number of pieces of content being used, and a content use pattern of the client.

The IF of a predetermined client in an SNS or the like may be individually generated in a client. For example, an IF of a client may be generated by using Equation (1) below.

IF=α*N+β*C+ [symbol] *L (where α+β+ [symbol] =1,α,β, [symbol] ≧0), (1)

In Equation (1), N denotes a number of neighbor clients of a client, C denotes a number of pieces of content that are used, and L denotes a content use pattern. That is, N denotes the number of registered friends (or subscribers) of the client, C denotes the number of pieces of content generated by the client per day, and L denotes the number of content that the client has forwarded (or provided links thereof) to other clients per day. By setting weights (e.g., α, β, and [symbol] ) to these factors (e.g., N, C, and L) differently, the IF may be determined according to a policy.

The reference client is a client whose content use influence information satisfies predetermined standards. For example, the reference client may be those clients whose IF is included in the upper 0.05.

Step S300 of generating a group including at least one neighbor client that has similar information as content preference information of the reference client includes step S310 of obtaining a content use pattern of the reference client; step S330 of extracting at least one neighbor client of the reference client based on similarity of a content use pattern of the at least one neighbor client with respect to the content use pattern of the reference client; and step S350 of generating a group including the extracted at least one neighbor client. In step S400, content data is transmitted by the reference client to the at least one neighbor client included in the generated group.

The content use pattern of each client according to the embodiment of the present invention may be stored in advance in a storage unit (not shown). Accordingly, by extracting a content use pattern of the reference client from the storage unit, a content use pattern of the reference client may be obtained.

In addition, from among the at least one neighbor client of the reference client, a client having a similar content use pattern as that of the reference client may be extracted. In other words, at least one neighbor client may be extracted based on similarity of the content use pattern.

For example, at least one neighbor client whose content use pattern has a similarity of about 85% or more with respect to that of the reference client from among clients included in a friend list or a subscriber list of the reference client determined based on the IF may be extracted. For example, in FIG. 1, if client B (or user B) 202 has a similarity of 0.89, client C (or user C) 203 has a similarity of 0.94, client D (or user D) 204 has a similarity of 0.53, and client E (or user E) 205 has a similarity of 0.47 as similarity in terms of the content use pattern with respect to that of the reference client (or reference user) A 201, then client B 202 and client C 203 may be extracted as neighbor clients with a relatively high similarity.

In other words, client B and client C may be extracted as neighbor clients based on similarity of content use patterns, and a group including client B and client C may be generated.

In addition, according to another embodiment of the present invention, the IF may be generated through a social influence analysis. For example, the social influence may be referred to as an information flow contributiveness.

This does not include a user such as a celebrity on an SNS who has a high popularity, but instead refers to an influencer who is able to have influence on other people's thoughts, emotions or actions may be selected as an information flow contributor who acts as a center or a hub of content flow. In other words, a person who has a large number of followers on Twitter or the like may very likely be a celebrity, but it should not be concluded that this person has a high impact in terms of content distribution. The impact in terms of content distribution may be determined based on the number of retweets or mentions.

In addition, the information flow contributiveness may also be generated not only in each client (e.g., clients 201 through 205) but on the side of a server (e.g., a server 300).

For example, the server 300 may obtain, from each SNS service provider (e.g., content provider 100), information about profiles of users (or clients) and about activities with neighbors (e.g., tweets, retweets, mentions, links, or follows).

Referring again to FIG. 1, the server 300 measures the importance of a user (or client) by using a wire that connects a node 401 and a node 402 to analyze the information flow contributiveness. As an analysis index for analysis of the information flow contributiveness, a number of connection lines (degree), betweenness centrality, closeness centrality, eigenvector centrality, a clustering coefficient, and/or the like may be used.

The reference client may be determined based on the information flow contributiveness that is measured by using the analysis index. For example, a user whose information flow contributiveness is within the upper 0.05 may be determined as a reference client.

In addition, as illustrated in FIG. 3, at least one neighbor client is extracted based on similarity thereof with respect to that of the reference client based on the information flow contributiveness.

For example, a client (e.g., client 201) having a relatively high information flow contributiveness may be set as a reference client, and a neighbor client is extracted by using a similarity measuring method which may be used in the field of data mining.

For example, based on content used by the reference client 201, a content matching technique based on Term Frequency-Inverse Document Frequency (TF-IDF) or a content matching technique based on a cosine similarity may be used to extract at least one neighbor client (e.g., clients 202 and 203) having a similar consumption pattern.

Also, at least one neighbor client (e.g., clients 202 and 203) may be extracted by using the above-described content matching method, a content-plus-link (CplusL) method using social link information, a Friend-of-Friend (FoF) method based on a social network relationship structure, or a Social Networking Architecture (SONAR) method in which a social network is analyzed by using an Intranet application.

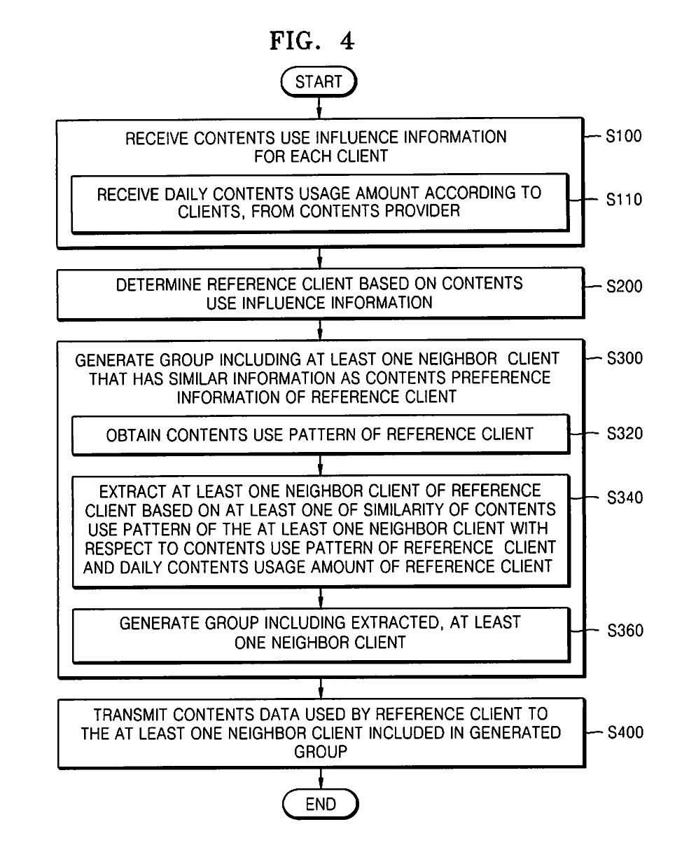

FIG. 4 is a flowchart illustrating a method of generating a group based on daily content usage amounts of a reference client and content preference similarity, according to an embodiment of the present invention.

Step S100 of receiving of content use influence information for each client includes step S120 of receiving daily content usage amounts according to clients, from a content provider.

The server 300 according to the embodiment of the present invention obtains content usage amounts of a client individually for each day from the content provider 100.

The server 300 determines a client having a predetermined consumption amount or more based on the daily content usage amounts, as a reference client 201. Also, the reference client 201 may be set differently for each day.

For example, on Tuesdays, a client whose content usage amount is included in the upper 5% may be determined as a reference client.

Also, step S300 of generating a group including at least one neighbor client that has similar information as content preference information of the reference client includes step S320 of obtaining a content use pattern of the reference client; step S340 of extracting at least one neighbor client of the reference client based on at least one of a similarity of a content use pattern of the at least one neighbor client with respect to a content use pattern of the reference client and the daily content usage amount of the reference client; and step S360 of generating a group including the extracted at least one neighbor client.

For example, as described above, a reference client 201 may be determined based on the daily content usage amounts. A content use pattern of the determined reference client 201 may be obtained from the storage unit (not shown). Also, a content use pattern of at least one client (e.g., clients 202 through 205) who uses a large amount of content on the same day as the reference client 201 may be obtained from the storage unit.

Also, at least one neighbor client (e.g., clients 202 and 203) may be extracted based on similarity with respect to a content use pattern of the reference client 201, from among at least one client (e.g., clients 202 through 205) that consumes a large amount of content on the same day as the reference client 201.

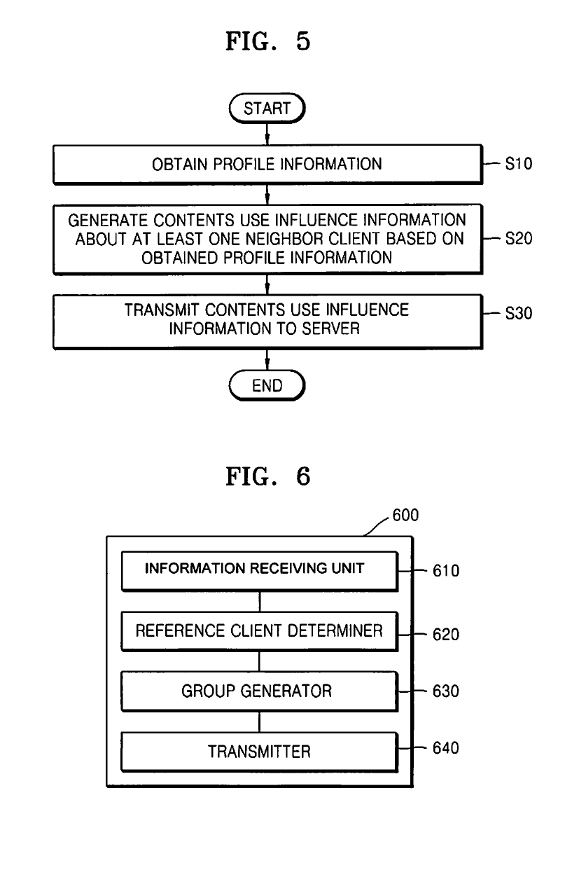

FIG. 5 is a flowchart illustrating a method of generating content use influence information in a client and transmitting the content use influence information to a server, according to an embodiment of the present invention.

The method of generating content use influence information with respect to at least one neighbor client by a client in a cloud environment and transmitting the information to a server may include: step S10 of obtaining profile information of a client; step S20 of generating content use influence information about at least one neighbor client based on the obtained profile information; and step S30 of transmitting the content use influence information to the server.

The profile information may include at least one of a number of neighbor clients of the client, a number of pieces of content used by the client, and a content use pattern of the client.

As described above, the IF may be generated on the side of the client 200 and be provided to the server 300.

FIG. 6 illustrates a block diagram of an apparatus 600 for transmitting content data to at least one client that is grouped in a cloud environment, according to an embodiment of the present invention.

The apparatus 600 for transmitting content data to at least one client that is grouped in a cloud environment includes an information receiving unit 610 for receiving content use influence information for each client; a reference client determiner 620 for determining a reference client based on the content use influence information; a group generator 630 for controlling to generate a group including at least one neighbor client that has similar information as content preference information of the reference client; and a transmitter 640 for transmitting content data used by the reference client to the at least one neighbor client included in the generated group.

The content use influence information for each client may include at least one of an IF regarding a neighbor client for each client and a daily content usage amount of each client.

The content use influence information for each client may be obtained in predetermined period units.

The reference client may be a client whose content use influence information satisfies predetermined criteria.

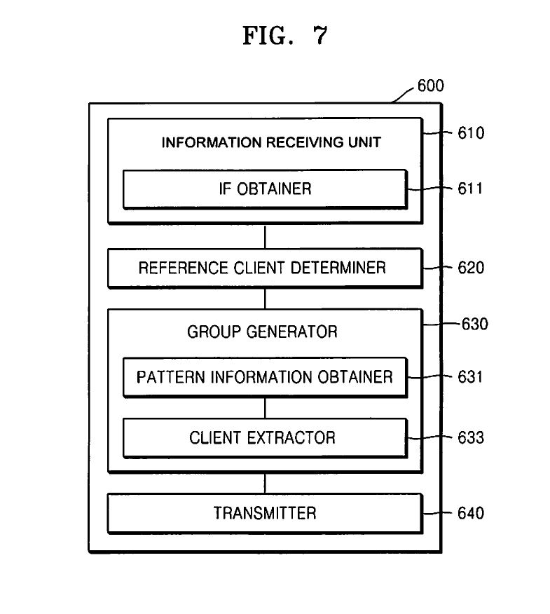

FIG. 7 illustrates a block diagram of an apparatus 600 for transmitting content data to at least one client that is grouped based on an IF in a cloud environment, according to an embodiment of the present invention.

The information receiving unit 610 includes an IF obtainer that receives the IF from each client. The IF may be generated in each client based on profile information of a client, and the profile information of the client includes at least one of a number of neighbor clients of the client, a number of pieces of content being used, and a content use pattern of the client.

The group generator 630 includes a pattern information obtainer 631 for obtaining a content use pattern of the reference client; and a client extractor 633 for extracting at least one neighbor client of the reference client based on a similarity of a content use pattern of the at least one neighbor client with respect to a content use pattern of the reference client. Also, the group generator 630 may generate a group including the extracted at least one neighbor client. The reference client determiner 620 and the transmitter 640 are the same as in the apparatus of FIG. 6.

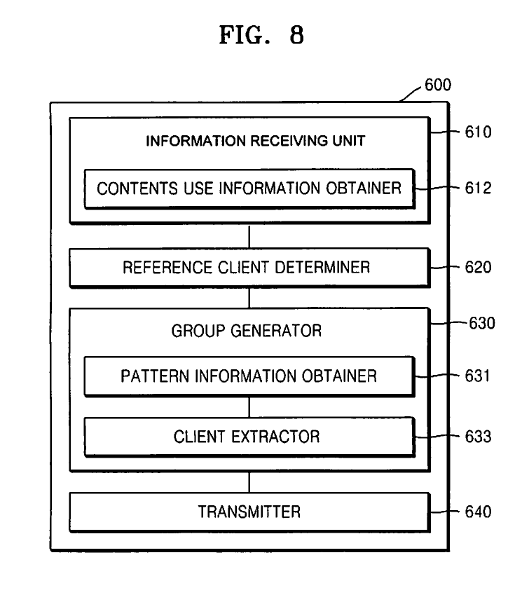

FIG. 8 illustrates a block diagram of an apparatus 600 for transmitting content data to at least one client that is grouped based on content use information in a cloud environment, according to an embodiment of the present invention.

The information receiving unit 610 includes a content use information obtainer 612 that receives a daily content usage amount according to each client, from a content provider.

The group generator 630 includes a pattern information obtainer 631 for obtaining a content use pattern of the reference client; and a client extractor 633 for extracting at least one neighbor client of the reference client based on a similarity of a content use pattern of the at least one neighbor client with respect to a content use pattern of the reference client. Also, the group generator 630 may generate a group including the extracted at least one neighbor client. The reference client determiner 620 and the transmitter 640 are the same as in the apparatus of FIG. 6.

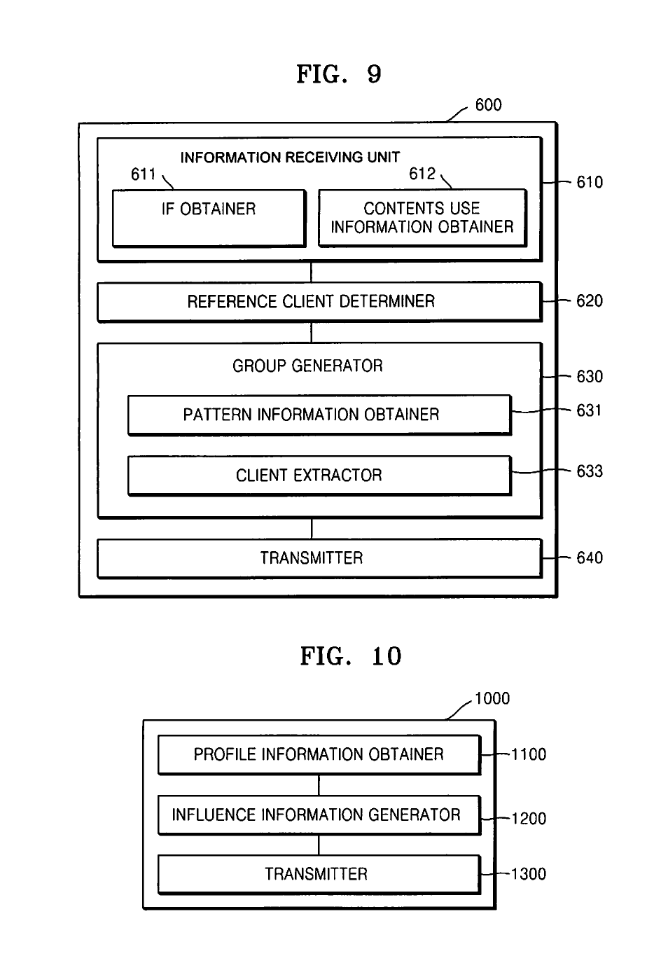

FIG. 9 illustrates a block diagram of an apparatus 600 for transmitting content data to at least one client that is grouped in a cloud environment, according to an embodiment of the present invention.

The apparatus 600 includes an information receiving unit 610, a reference client determiner 620, a group generator 630, and a transmitter 640. The information receiving unit 610 includes an IF obtainer 611 and a content use information obtainer 612. The group generator 630 includes a pattern information obtainer 631 and a client extractor 633.

FIG. 10 illustrates a block diagram of a client 1000 that generates content use influence information and transmits the content use influence information to a server, according to an embodiment of the present invention.

The client 1000 that generates content use influence information and transmits the content use influence information to a server includes a profile information obtainer 1100 for obtaining profile information of a client; an influence information generator 1200 for generating content use influence information about at least one neighbor client based on the obtained profile information; and a transmitter for transmitting the content use influence information to a server.

The profile information includes at least one of a number of neighbor clients of the client, a number of pieces of content used by the client, and a content use pattern of the client.

The group in which at least one neighbor client of the reference client is included may be generated in a network in which the reference client is included or in a network that is different from the network in which the reference client is included. That is, content data to at least one neighbor client of the reference client may be transmitted between different networks.

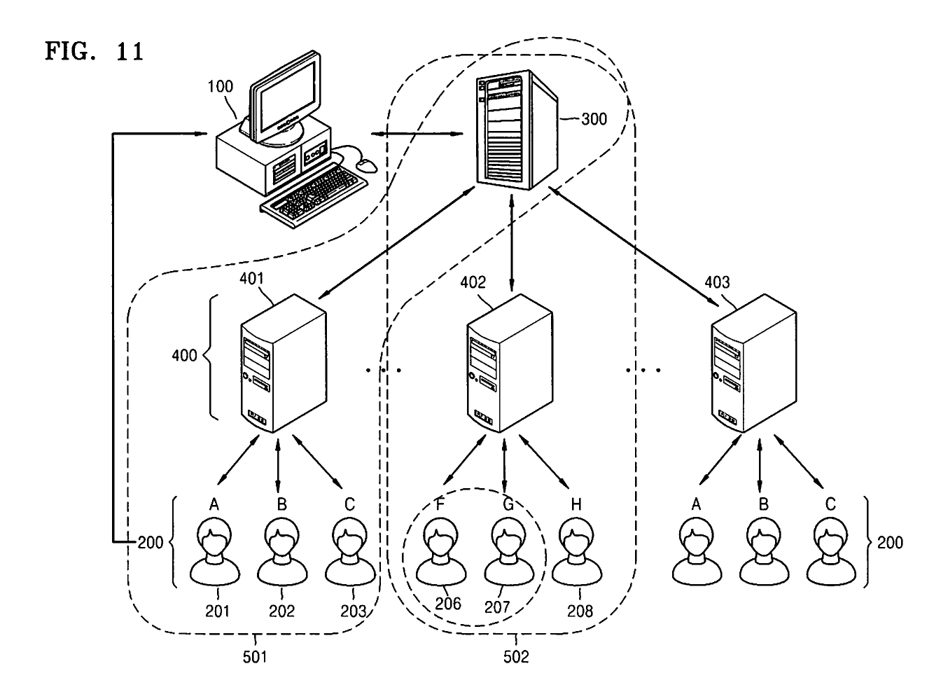

Steps of the method and apparatus according to the above-described embodiments of the present invention may be performed overall in a network in which the reference client is included or both in the network in which the reference client is included and in a network not including the reference client. This will be described in detail below with reference to FIGS. 11 through 13.

FIG. 11 is a schematic view illustrating a method of transmitting content data between different networks, according to an embodiment of the present invention.

In a cloud environment including a first network 501 that includes an edge server 401 and a second network 502 that includes an edge server 402, content data that is used by a reference client 201 may be transmitted to at least one client (e.g., clients 206 and 207) that is included in the second network 502 and is grouped.

The reference client 201 may be determined based on user influence information as described above.

The first network 501 and the second network 502 may include a Content Delivery Network (CDN). Also, the first network 501 and the second network 502 may be geographically adjacent or distant. Also, when the first network 501 and the second network 502 are geographically adjacent, the first network 501 and the second network 502 may be physically distinguished, separate networks.

According to an embodiment of the present invention, at least one neighbor client that is included in the second network 502 and has similar content preference information as that of the reference client included in the first network 501 may be extracted and a group including the extracted, at least one neighbor client may be generated.

By transmitting content data used by the reference client to the at least one neighbor client in the group such that the content data is included in the second network 502, content data may be transmitted between different networks. In other words, content data is transmitted between different networks in consideration of a content use pattern of the reference client and that of a neighbor client so that a client may quickly use high quality content data without being limited just by a network in which the client is included.

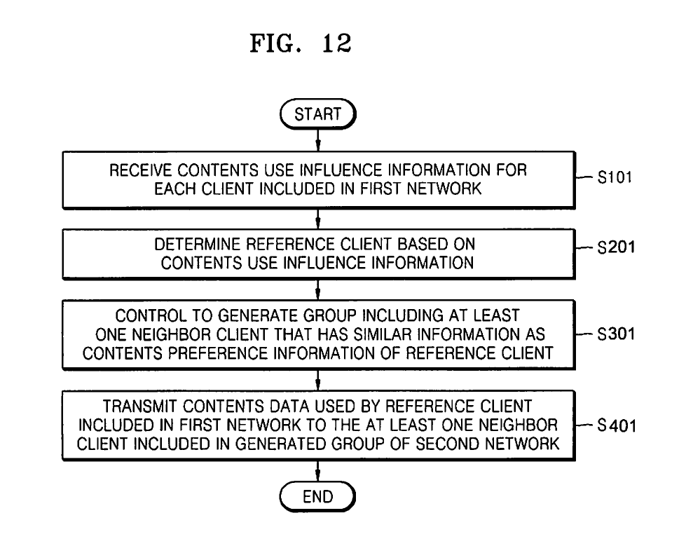

FIG. 12 is a flowchart illustrating a method of transmitting content data between different networks, according to an embodiment of the present invention.

The method of transmitting, in a cloud environment including a first CDN and a second CDN, content data to at least one client that is included in the second CDN and is grouped, includes step S101 of receiving content use influence information for each client included in the first CDN; step S201 of determining a reference client based on the content use influence information; step 301 of controlling to generate a group including at least one neighbor client that has similar information as content preference information of the reference client; and step S401 of transmitting content data used by the reference client included in the first CDN to the at least one neighbor client included in the generated group of the second CDN.

The same description for steps S100 through S400 described with reference to FIG. 2 may apply to steps S101 through S401. That is, steps S101 through S401 illustrate that steps S100 through S400 of FIG. 2 may also be performed in different networks.

In addition, an apparatus 600 for transmitting, in a cloud environment including a first CDN and a second CDN, content data to at least one client that is included in the second CDN and is grouped, according to an embodiment of the present invention, includes, as illustrated in FIG. 6, an information receiving unit 610, a reference client determiner 620, a group generator 630, and a transmitter 640.

That is, the information receiving unit 610 of the apparatus 600 receives content use influence information for each client, included in the first CDN.

Also, the reference client determiner 620 determines a reference client among at least one client included in the first CDN based on the content use influence information.

Also, the group generator 630 controls to generate a group including at least one neighbor client that has similar information as content preference information of the reference client. Also, the at least one neighbor client is included in the second CDN.

Also, the transmitter 640 transmits content data used by the reference client included in the first CDN to the at least one neighbor client included in the generated group of the second CDN.

As described above, according to the one or more of the above embodiments of the present invention, by performing content prefetching based on groups consisting of at least one client that has a similar content consumption pattern as that of a reference client or social similarity to the reference client, reliability in content demand prediction may be increased compared to content prefetching based on a single user. In addition, serial content consumption based on a group-based content prefetching may be performed, and content may be transmitted at a higher speed compared to the conventional art.

The embodiments of the present invention may be written as computer programs that may be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While this invention has been particularly shown and described with reference to certain embodiments thereof, it will be understood by those of ordinary skill in the art that various changes in form and details may be made therein without departing from the spirit and scope of the invention as defined by the appended claims. The above-described embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of transmitting content data to at least one client that is grouped in a cloud environment, the method comprising:
receiving content use influence information for each client;
determining a reference client based on the content use influence information;
generating a group including at least one neighbor client that has similar information as content preference information of the reference client; and
transmitting content data used by the reference client to the at least one neighbor client included in the generated group.

2. The method of claim 1, wherein the content use influence information for each client comprises at least one of an Impact Factor (IF) regarding a neighbor client for each client and a daily content usage amount for each client.

3. The method of claim 2, wherein the content use influence information for each client is obtained in predetermined period units.

4. The method of claim 2, wherein the reference client is a client whose content use influence information satisfies predetermined criteria.

5. The method of claim 2, wherein receiving content use influence information for each client comprises receiving the IF from each client,
wherein the IF is generated in each client based on profile information of a client, and
wherein the profile information of the client comprises at least one of a number of neighbor clients of the client, a number of pieces of content being used, and a content use pattern of the client.

6. The method of claim 2, wherein generating a group including at least one neighbor client that has similar information as the content preference information of the reference client comprises:
obtaining a content use pattern of the reference client;
extracting at least one neighbor client of the reference client based on similarity of a content use pattern of the at least one neighbor client with respect to the content use pattern of the reference client; and
generating a group including the extracted at least one neighbor client.

7. The method of claim 2, wherein receiving content use influence information for each client comprises receiving a daily content usage amount according to clients, from a content provider.

8. The method of claim 7, wherein generating a group including at least one neighbor client that has similar information as the content preference information of the reference client comprises:
obtaining a content use pattern of the reference client;
extracting at least one neighbor client of the reference client based on at least one of a similarity of a content use pattern of the at least one neighbor client with respect to a content use pattern of the reference client and the daily content usage amount of the reference client; and
generating a group including the extracted at least one neighbor client.

9. A method of transmitting data, the method comprising:
obtaining profile information of a client;
generating content use influence information about at least one neighbor client based on the obtained profile information; and
transmitting the content use influence information to a server,
wherein the profile information comprises at least one of a number of neighbor clients of the client, a number of pieces of content used by the client, and a content use pattern of the client.

10. An apparatus for transmitting content data to at least one client that is grouped in a cloud environment, the apparatus comprising:
an information receiving unit configured to receive content use influence information for each client;
a reference client determiner configured to determine a reference client based on the content use influence information;
a group generator configured to generate a group including at least one neighbor client that has similar information as content preference information of the reference client; and
a transmitter configured to transmit content data used by the reference client to the at least one neighbor client included in the generated group.

11. The apparatus of claim 10, wherein the content use influence information for each client comprises at least one of an Impact Factor (IF) regarding a neighbor client for each client and a daily content usage amount of each client.

12. The apparatus of claim 11, wherein the content use influence information for each client is obtained in predetermined period units.

13. The apparatus of claim 11, wherein the reference client is a client whose content use influence information satisfies predetermined criteria.

14. The apparatus of claim 11, wherein the information receiving unit comprises an IF obtainer configured to receive the IF from each client,
wherein the IF is generated in each client based on profile information of a client, and
wherein the profile information of the client comprises at least one of a number of neighbor clients of the client, a number of pieces of content being used, and a content use pattern of the client.

15. The apparatus of claim 14, wherein the group generator comprises:
a pattern information obtainer configured to obtain a content use pattern of the reference client; and
a client extractor configured to extract at least one neighbor client of the reference client based on a similarity of a content use pattern of the at least one neighbor client with respect to a content use pattern of the reference client,
wherein the group generator is configured to generate a group including the extracted, at least one neighbor client.

16. The apparatus of claim 10, wherein the information receiving unit comprises a content use information obtainer configured to receive a daily content usage amount according to clients, from a content provider.

17. The apparatus of claim 16, wherein the group generator comprises:
a pattern information obtainer configured to obtain a content use pattern of the reference client; and
a client extractor configured to extract at least one neighbor client of the reference client based on at least one of a similarity of a content use pattern of the at least one neighbor client with respect to the content use pattern of the reference client and the daily content usage amount of the reference client,
wherein the group generator is configured to generate a group including the extracted at least one neighbor client.

18. A client comprising:
a profile information obtainer configured to obtain profile information of a client;
an influence information generator configured to generate content use influence information about at least one neighbor client based on the obtained profile information; and
a transmitter configured to transmit the content use influence information to a server,
wherein the profile information comprises at least one of a number of neighbor clients of the client, a number of pieces of content used by the client, and a content use pattern of the client.

19. A method of transmitting, in a cloud environment including a first Content Delivery Network (CDN) and a second CDN, content data to at least one client that is included in the second CDN and is grouped, the method comprising:
receiving content use influence information for each client included in the first CDN;
determining a reference client based on the content use influence information;
generating a group including at least one neighbor client that has similar information as content preference information of the reference client; and
transmitting content data used by the reference client included in the first CDN to the at least one neighbor client included in the generated group of the second CDN.

20. An apparatus for transmitting, in a cloud environment including a first Content Delivery Network (CDN) and a second CDN, content data to at least one client that is included in the second CDN and is grouped, the method comprising:
an information receiving unit configured to receive content use influence information for each client, included in the first CDN;
a reference client determiner configured to determine a reference client based on the content use influence information;
a group generator configured to generate a group including at least one neighbor client that has similar information as content preference information of the reference client; and
a transmitter configured to transmit content data used by the reference client included in the first CDN to the at least one neighbor client included in the generated group of the second CDN.

21. A method of transmitting, in a cloud environment including a first Content Delivery Network (CDN) and a second CDN, content data to at least one client that is included in the second CDN and is grouped, the method comprising:
receiving content use influence information for each client included in the first CDN;
determining a reference client based on the content use influence information;
transmitting a first signal to the second CDN to generate a group including at least one neighbor client that has relevant information as content preference information of the reference client; and
transmitting a second signal to a server to transmit content data used by the reference client included in the first CDN to the at least one neighbor client included in the generated group of the second CDN.

22. A non-transitory computer readable recording medium having embodied thereon a program for executing a method of transmitting content data to at least one client that is grouped in a cloud environment, the method comprising:
receiving content use influence information for each client;
determining a reference client based on the content use influence information;
generating a group including at least one neighbor client that has similar information as content preference information of the reference client; and
transmitting content data used by the reference client to the at least one neighbor client included in the generated group.

23. A non-transitory computer readable recording medium having embodied thereon a program for executing a method of transmitting data, the method comprising:
obtaining profile information of a client;
generating content use influence information about at least one neighbor client based on the obtained profile information; and
transmitting the content use influence information to a server,
wherein the profile information comprises at least one of a number of neighbor clients of the client, a number of pieces of content used by the client, and a content use pattern of the client.

24. A non-transitory computer readable recording medium having embodied thereon a program for executing a method of transmitting, in a cloud environment including a first Content Delivery Network (CDN) and a second CDN, content data to at least one client that is included in the second CDN and is grouped, the method comprising:
receiving content use influence information for each client included in the first CDN;
determining a reference client based on the content use influence information;
generating a group including at least one neighbor client that has similar information as content preference information of the reference client; and
transmitting content data used by the reference client included in the first CDN to the at least one neighbor client included in the generated group of the second CDN.

25. A non-transitory computer readable recording medium having embodied thereon a program for executing a method transmitting, in a cloud environment including a first Content Delivery Network (CDN) and a second CDN, content data to at least one client that is included in the second CDN and is grouped, the method comprising:
receiving content use influence information for each client included in the first CDN;
determining a reference client based on the content use influence information;
transmitting a first signal to the second CDN to generate a group including at least one neighbor client that has relevant information as content preference information of the reference client; and
transmitting a second signal to a server to transmit content data used by the reference client included in the first CDN to the at least one neighbor client included in the generated group of the second CDN.
